(19) United States
(12) Patent Application Publication
(10) Pub. No.: US 2017/0302095 A1
(43) Pub. Date: Oct. 19, 2017

(54) SMART CHARGER WITH SELECTIVE DISCHARGE CAPABILITY

(71) Applicant: VITEC VIDEOCOM INC., Chatsworth, CA (US)

(72) Inventors: William E. Flynn, JR., Naugatuck, CT (US); James J. Boutin, Hollis, ME (US); David Vincent Jervis, Milford, CT (US); Jason Joaquim Pinheiro, Shelton, CT (US)

(21) Appl. No.: 15/490,713

(22) Filed: Apr. 18, 2017

Related U.S. Application Data
(60) Provisional application No. 62/324,282, filed on Apr. 18, 2016.

(51) Int. Cl. H02J 7/00

(52) U.S. Cl. CPC H02J 7/0068; H02J 2007/0067

(57) ABSTRACT

A battery discharging system includes a discharging circuit, a battery bay, and a controller electrically interposing the discharger and the battery bay. When a battery is connected to the battery bay the controller operatively couples the battery to the discharger until the battery is discharged below a predetermined threshold.

### CROSS-REFERENCE TO RELATED CASES

This application claims the benefit of U.S. provisional patent application Ser. No. 62/324,282, filed on Apr. 18, 2016 and incorporates such provisional application by reference into this disclosure as if fully set out at this point.

### FIELD OF THE INVENTION

This disclosure relates to battery technology in general and, more specifically, to battery chargers that provide discharge capabilities.

### BACKGROUND OF THE INVENTION

Certain battery technologies may require that individual cells or batteries be discharged for safe storage or for certain types of travel (e.g., air travel). Some batteries will self-discharge on their own although this process can take unacceptably long, and is considered an undesirable trait for batteries under most circumstances. Batteries can also be discharged by use, but batteries are generally engineered to provide as much usable capacity as possible for the size and price, which would make discharging them by use slow and inconvenient. Storing batteries in a discharged state is often detrimental to the chemistry of the battery and it means the battery will not be in a usable state when it is needed.

What is needed is a system and method for addressing the above, and related, issues.

### SUMMARY OF THE INVENTION

The invention of the present disclosure, in one aspect thereof, comprises a battery discharging system including a discharging circuit, a battery bay, and a controller electrically interposing the discharger and the battery bay. When a battery is connected to the battery bay the controller operatively couples the battery to the discharger until the battery is discharged below a predetermined threshold.

The controller may accept a user provided predetermined threshold. Multiple battery bays may be connected to the controller and these may be user selectable for discharge operation. The controller may share a discharging circuit capable of discharging fewer batteries than a plurality of battery bays among the plurality of battery bays.

The controller may communicate with the battery to receive a report from the battery of its current level of charge. The system may further comprising a charging circuit controlled by the controller to activate a battery charging function on one or more of the battery bays.

The invention of the present disclosure, in another aspect thereof, comprises a battery discharging system having a controller, a discharge circuit, and a plurality of battery bays. The controller compares a first charge level from a first battery placed in one of the bays to a threshold charge level and selectively connects the discharge circuit to the battery bay containing the first battery when the charge level is higher than the threshold charge level.

The system may also disconnect the first battery from the discharge circuit when the first charge level falls below the threshold charge level. After disconnecting the first battery, the controller may compare a charge level from a second battery placed in one of the bays to the threshold charge level and selectively connect the discharge circuit to the battery bay containing the second battery when the second charge level is higher than the threshold charge level.

The first and second batteries may each occupy one of the plurality of battery bays simultaneously. The threshold charge level may be user definable via the controller. The controller may receives the first and/or second charge level from a self report of the respective battery. The system can include battery charging circuitry controlled by the controller for selectively charging batteries in the plurality of bays.

The invention of the present disclosure, in another aspect thereof comprises a method including providing a battery discharge circuit, providing a plurality of battery bays, using an electronic controller to determine a first charge level of a first battery connected to one of the plurality of battery bays, and using the electronic controller to compare the first charge level to a threshold charge amount and if the first charge level exceeds the threshold charge amount, connecting the first battery to the first discharge circuit until the first charge level does not exceed the threshold charge amount.

The method may include using the electronic controller to determine a second charge level of a second battery connected to another one of the plurality of battery bays and using the electronic controller to compare the second charge level to the threshold charge amount and if the second charge level exceeds the threshold charge amount, connecting the first second battery to the first discharge circuit until the second charge level does not exceed the threshold charge amount.

The method may further comprise accepting the threshold charge amount at the electronic controller from a user. The first charge level may be reported from the first battery or determined using a voltmeter.

### BRIEF DESCRIPTION OF THE DRAWINGS

FIG. 1 is a schematic diagram of a smart charger with selective discharge capability according to aspects of the present disclosure.

FIG. 2 is a flow diagram of a simplified method of operation of a smart charger with selective discharge capability according to aspects of the present disclosure

FIG. 3 is a flow diagram of a method of operation of a smart charger with selective discharge capability and multiple battery bays according to aspects of the present disclosure.

FIG. 4 is a simplified schematic diagram of a battery discharge circuit according to aspects of the present disclosure.

FIG. 5 is a perspective view of one physical embodiment of a smart charger with selective discharge capability according to aspects of the present disclosure.

### DETAILED DESCRIPTION OF THE PREFERRED EMBODIMENTS

The present disclosure, in various embodiments, provides a battery discharge device that discharges or drains a battery to a predetermined level. Some battery technologies are regulated with regard to their charge condition when travelling (e.g., by air). For example, regulations exist that require lithium-ion batteries to be discharged to 30% (or lower) of their capacity to be allowed to fly in the cargo hold of a commercial airliner. A device according to the present disclosure may be operatively connected to such a battery and will discharge the battery down to the 30% threshold. In some embodiments the device will discharge the battery to another predetermined or user selected amount.

In some embodiments, the discharge device is also a charger. For example, the Performance line of battery chargers from Anton Bauer® may be programmed to not only charge batteries, but also to discharge batteries to 30% (or another predetermined or preselected threshold). Any additional controls or switchgear necessary to operate the discharge function may be added to such a charger.

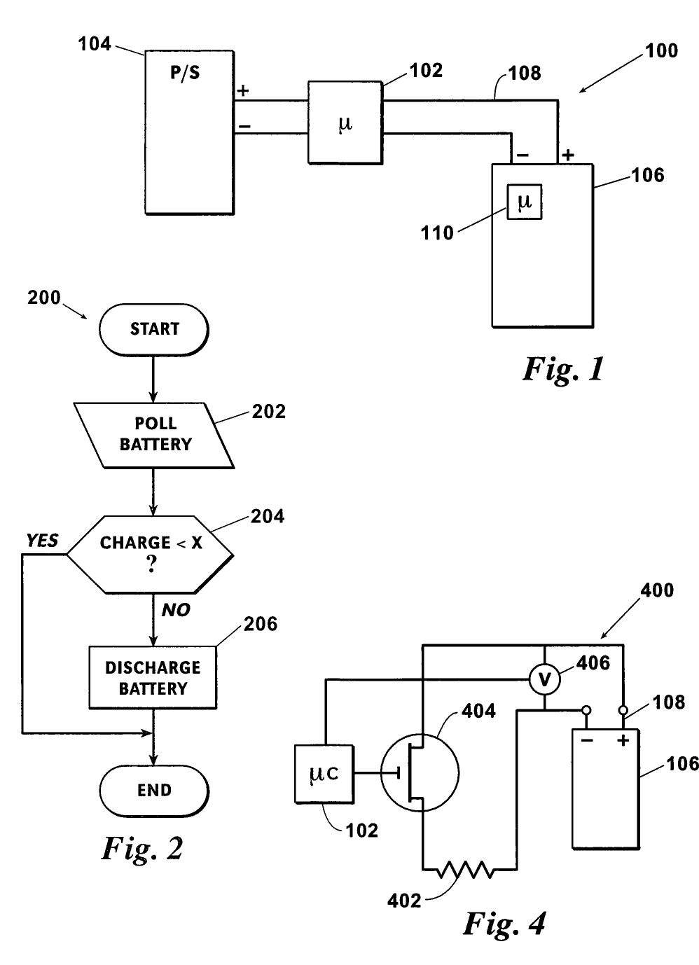

Referring now to FIG. 1 is a schematic diagram of a smart charger with selective discharge capability according to aspects of the present disclosure. The schematic of FIG. 1 is simplified in order to show the logical components of one embodiment of a smart charger with selective discharge capability 100 according to aspects of the present disclosure. The charger 100 may be based around a controller 102. The controller 102 may provide one or more microcontrollers, memory arrays, I/O chips and other components necessary to operation of the charger 100.

The controller 102 is interconnected to a power supply 104. The power supply 104 may be a wall outlet (e.g., 110/220 volts A/C at 50/60 Hz). The power supply 104 could also be a high capacity battery (lithium ion, lead acid, or based on other chemistry) or other DC supply. In one embodiment, the charger 100 connects to the 12 V DC outlet of a vehicle. Normally, DC power is utilized to operate control components, and various waveforms or voltages (e.g., other than 110/220V 50/60 Hz) are used to charge batteries. Accordingly, the controller 102 may provide various inverters, rectifiers, and power conditioning circuitry as needed to operate itself and to charge batteries.

A battery 106 is shown connected to the controller 102 via leads 108. Physically, the connection may be any suitable connection as known in the art. Non-limiting examples include Gold Mounts or V-Mounts. A single charging system may also be able to service multiple batteries at once. The battery 106 may be a smart battery that is capable of reporting its own state of charge or discharge. One non-limiting example of such a battery is the Cine 90 battery from Anton Bauer®. The battery 106 may contain one or more microcontrollers 110 that monitor the power level (and possibly other data) within the battery 106. Information about the state of the battery 106 may be communicated to the controller 102 via the power leads 108 or other leads or connections.

Referring now to FIG. 4, a simplified schematic diagram of a battery discharge circuit 400 according to aspects of the present disclosure is shown. As discussed above, battery chargers of the present disclosure provide for discharge capability of batteries. The circuit 400 is a simplified representation hardware for safely achieving a battery discharge. It should be understood that additional components and subcomponents may be present in a commercial embodiment. It should also be understood that one of skill in the art might design a different discharge circuit depending upon the needs and constraints of the product.

The battery 106 may be selectively connected to the circuit 400 via power leads 108. The controller 102 may be able to sense the available voltage of the battery 106 via on board voltmeter 406 connected across terminals or power leads 108. It is known that batteries offer a decreasing voltage as they are discharged, even where the voltage curve is relatively flat (e.g., as in the case of a lithium ion battery). As explained with respect to FIG. 1, the battery 106 may be able to report its remaining capacity, maximum capacity, and/or maximum and current voltage to the microcontroller 102 such that it can be determined what the maximum voltage would be, and thus the current state of charge of the battery 106 can be determined. In another embodiment, the circuit 400 is intended to work only with batteries of a specific maximum voltage (e.g., 3.7 volts) and the controller 102 would not need to be in communication with the battery 106 to determine the current state of charge. In yet another embodiment, the user may provide an input setting to the controller 102 indicative of the type of battery attached. This could be via a selector switch, touch screen, etc. It should be understood that the systems and methods of the present disclosure can also work with battery charge level measurements other than voltage (e.g., load testing or coulomb counting).

The controller 102 may determine that the battery 106 is over the level to which it should be discharged based upon the reading from the voltmeter 406. A load 402 may be connected to the battery terminals to drain the battery. The load 402 is shown here as a simply resistor. However, a more complex resistive, capacitive, and/or inductive network might be utilized. In some cases, to provide desired and rapid drain characteristics, the load might be made to vary over time. In the embodiment shown, the battery 106 is electrically attached and detached from the load 402 via a transistor switch 404. The transistor 404, under control of the controller 102, selectively completes the circuit between the battery 106 and the load 402 while providing isolation and protection to the controller 102. It should be appreciated that one of skill in the art could conceive of a number of ways to implement switching and loading of the battery 106 and that the circuit 400 is intended to be exemplary.

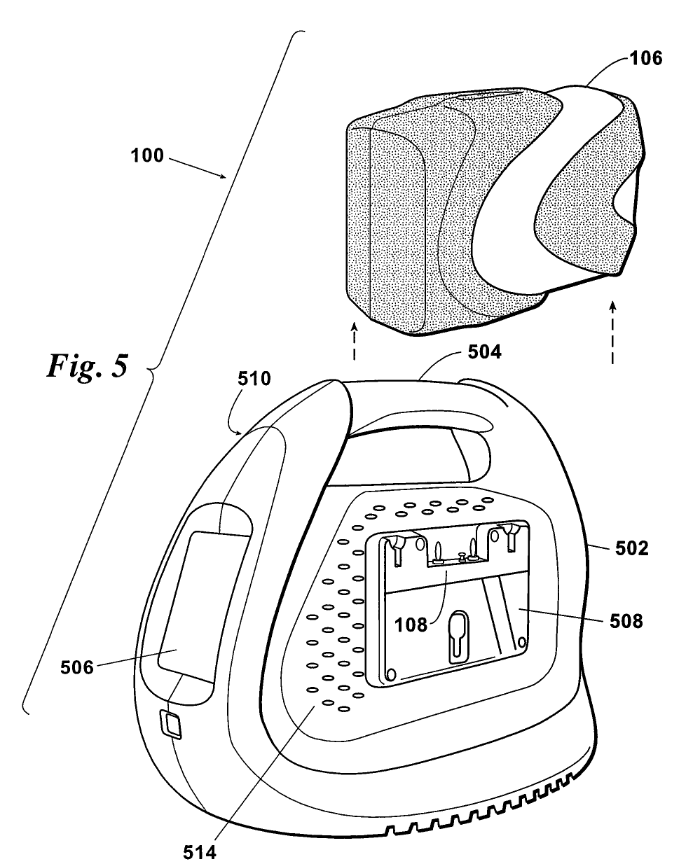

Referring now to FIG. 5, a perspective view of one physical embodiment of a smart charger 100 with selective discharge capability according to aspects of the present disclosure is shown. The physical appearance of the charger 100 can vary from that shown without effect on the charge/discharge features discussed herein. However, certain physical forms can improve usability, heat dissipation, etc. In the present embodiment, the charger 100 comprises a polymer casing 502. Polymer may be selected due to its durability and easy of manufacture. Polymers are generally nonconductive but a metallic or conductive casing could be used with proper grounding and other safety protocols. For ease of transport a handle 504 may be provided. The handle 504 may be molded as part of the case 502 or attached separately.

As discussed above, a user may be provided the option of inputting parameters or commands to the charger 100. A touch screen 506 may fulfill this purpose. For example, a user may be provided by the controller 102 or other component with an interface on the touch screen 506 where commands can be provided. Commands to charge or discharge are two exemplary commands. Parameters may also be provided via the touch screen such as desired discharge level, battery type, slow or fast charge/discharge, etc. Inputs or parameters could also be provided to the charger 100 via buttons, switches, or other means.

The charger 100 may also display information to the user via the touch screen 506. The charge state of any connected batteries might be shown. Any other errors or faults with the batteries or otherwise might be provided via the touch screen 506 as well. Instead of or in addition to the touch screen, the charger may provide user feedback via indicators lights, audio warnings, etc.

The charger 100, as illustrated, provides two battery bays 508, 510 (out of frame) but a single battery device is also within the scope of this disclosure. Some embodiments provide three, four, or more battery bays or more. Some embodiments provide for charge and/or discharge of one or more batteries, and storage-only for one or more additional batteries.

The battery ports, such as bay 508, provide physical securement of the battery being charged or discharged as well as the electrical connection to the battery in the form of power leads 108. As discussed above, the battery 106 may be able to provide battery information such as health and charge state via the power leads 108 or another connection to the controller 102 within the charger 100.

In various operations such as charging or discharging, power may be dissipated within the charger 100 in the form of heat (e.g., when resistive elements are employed). Accordingly, the case 502 may be provided with one or more ventilation panels 514. Heat sinks may be employed at various locations inside the case 502 and active cooling (e.g., fans) may be deployed if needed.

Referring now to FIG. 2, a flow diagram of a simplified method of operation of a smart charger with selective discharge capability according to aspects of the present disclosure. When connected to a battery for discharge purposes, the battery may be polled at step 202. At this step, the battery and charger may communicate electronically to allow the charger to determine the level of charge currently existing in the battery. At step 204 the charge level is compared against a threshold. In some embodiments, the threshold is 30%. However, other thresholds may be used (e.g., 50%, 10%, or others) and the threshold may be user selectable. For example, discharging a battery in preparation for flying may require 30%. On the other hand, 80% may be desirable for long term storage of a battery having a certain chemistry to prolong the life of the battery while in storage.

If the battery is already below the threshold as determined at step 204, no action may be needed. On the other hand, if the battery is charged to beyond the threshold as determined at step 204, the battery may be discharged below the threshold as shown at step 206.

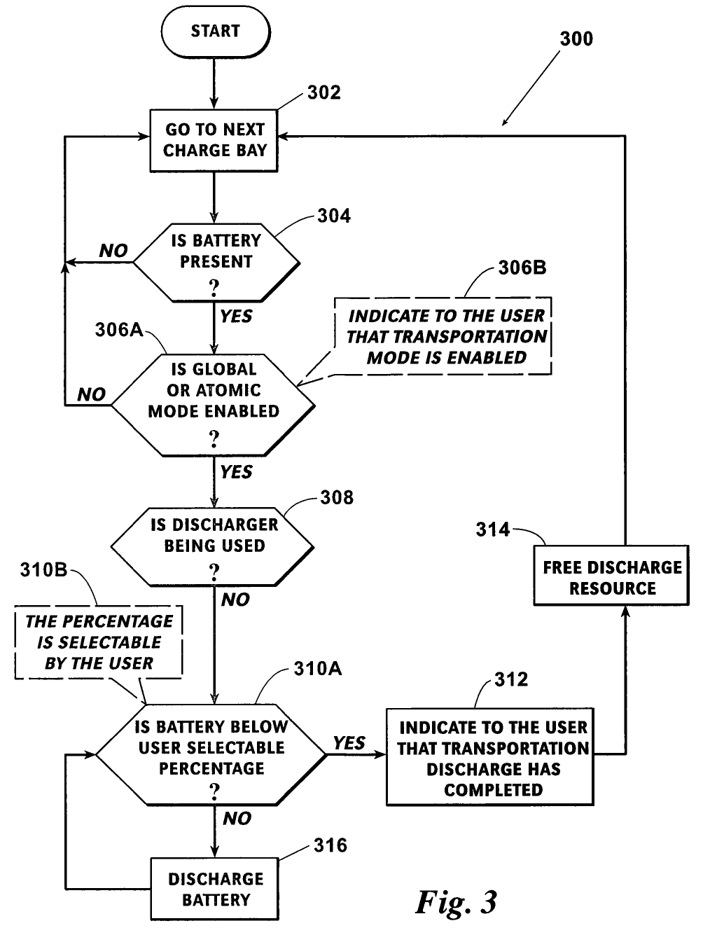

Referring now to FIG. 3, a flow diagram of a method of operation of a smart charger with selective discharge capability and multiple battery bays according to aspects of the present disclosure is shown. The flow diagram 300 corresponds to a fuller featured version of the charger of the present disclosure such as might be based upon a multi-bay charge such as a Performance battery charger from Anton Bauer®. The indication and display capabilities referenced herein may occur on a touchscreen 506 on the charger 100 as illustrated in FIG. 5.

At step 302, the next charge bay may be selected (e.g., by an internal controller such as controller 102 of FIG. 1). At step 304 it is determined whether a battery is present (this is done electronically). If not, the next bay may be selected again at step 302. If a battery is present, a determination is made at step 306A as to whether the currently selected bay is set or configured to provide a smart discharge function. Such a feature may be set by a user. If the bay is not set for discharge operations, the next bay may be selected again at step 302. The user may be informed as to whether a discharge operation is to be performed as shown at step 306B.

It should be understood that some systems of the present disclosure allow a user to select whether the entire charger (e.g., every bay) performs the discharge operation, whether each bay may be set individually to perform discharge functions, or whether all bays provide charging operations but not discharge operations. A graphical indication on the charger shows the user that the charger is in either discharge mode or charge only mode (e.g., view touch screen 506).

If it is determined at step 306A that the current battery bay should perform a discharge operation a determination is made at step 308 as to whether there is a discharger available. Some systems may have more than one discharger but in some cases more bays may be provided that dischargers within the system. If a discharger is not available, the system will wait until one becomes free. The discharger may be based on a resistive network adequately capable of dissipating excess heat, or other technology as is known in the art.

At step 310A a determination is made as to whether the battery in the current bay is below the user selectable percentage. The percentage may be set by the user as shown at step 310B (this can occur prior to the other operations of flow diagram 300). If the battery is not below the desired percentage, a discharge operation occurs at step 316. This is shown logically as a loop. As soon as the system determines (step 310A) that the battery is below the selected percentage it may be indicated to the user at step 312 that discharge has completed. Otherwise, the discharge operation continues as shown at step 316. When the battery has been sufficiently discharged, the system releases the discharge resources at step 314 (as the same may be needed for another battery bay).

In some embodiments, a user may interact with the charger 100 (e.g., via touchscreen 506) to place the charger 100 into a “global transportation discharge mode” wherein the touchscreen 506 indicates that such mode is active and the charger 100 only operates to discharge batteries but does not provide any charging functionality. The charger 100 may also have separately selectable “global” and “atomic” modes. Global mode may indicate that each battery bay performs the same function (e.g., discharge to a specified or predetermined level). Atomic mode can indicate that various battery bays can perform different concurrent operations (e.g., discharging to different levels or discharging on one bay while charging on another).

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not to be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)−(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A battery discharging system comprising:
a discharging circuit;
a battery bay; and
a controller electrically interposing the discharger and the battery bay;
wherein, when a battery is connected to the battery bay the controller operatively couples the battery to the discharger until the battery is discharged below a predetermined threshold.

2. The system of claim 1, wherein the controller accepts a user provided predetermined threshold.

3. The system of claim 1, further comprising multiple battery bays connected to the controller.

4. The system of claim 4, wherein multiple battery bays are user selectable for discharge operation.

5. The system of any claim 1, wherein the controller communicates with the battery to receive a report from the battery of its current level of charge.

6. The system of claim 1, wherein the controller shares a discharging circuit capable of discharging fewer batteries than a plurality of battery bays among the plurality of battery bays.

7. The system of claim 1, further comprising a charging circuit controlled by the controller to activate a battery charging function on the battery bay.

8. A battery discharging system comprising:
a controller;
a discharge circuit; and
a plurality of battery bays;
wherein the controller compares a first charge level from a first battery placed in one of the bays to a threshold charge level and selectively connects the discharge circuit to the battery bay containing the first battery when the charge level is higher than the threshold charge level.

9. The system of claim 8, wherein the controller disconnects the first battery from the discharge circuit when the first charge level falls below the threshold charge level.

10. The system of claim 9, wherein after disconnecting the first battery, the controller compares a charge level from a second battery placed in one of the bays to the threshold charge level and selectively connects the discharge circuit to the battery bay containing the second battery when the second charge level is higher than the threshold charge level.

11. The system of claim 10, wherein the first and second batteries each occupy one of the plurality of battery bays simultaneously.

12. The system of claim 8, wherein the threshold charge level is user definable via the controller.

13. The system of claim 8, wherein the controller receives the first charge level from a self report of the first battery.

14. The system of claim 8, further comprising battery charging circuitry controlled by the controller for selectively charging batteries in the plurality of bays.

15. A method comprising:
providing a battery discharge circuit;
providing a plurality of battery bays;
using an electronic controller to determine a first charge level of a first battery connected to one of the plurality of battery bays;
using the electronic controller to compare the first charge level to a threshold charge amount and if the first charge level exceeds the threshold charge amount, connecting the first battery to the first discharge circuit until the first charge level does not exceed the threshold charge amount.

16. The method of claim 15, further comprising using the electronic controller to determine a second charge level of a second battery connected to another one of the plurality of battery bays;
using the electronic controller to compare the second charge level to the threshold charge amount and if the second charge level exceeds the threshold charge amount, connecting the first second battery to the first discharge circuit until the second charge level does not exceed the threshold charge amount.

17. The method of claim 15, further comprising accepting the threshold charge amount at the electronic controller from a user.

18. The method of claim 15, further comprising receiving the first charge level as a report from the first battery.

19. The method of claim 15, further comprising determining the first charge level using a voltmeter.
